(19) United States
(12) Patent Application Publication
(10) Pub. No.: US 2026/0170741 A1
(43) Pub. Date: Jun. 18, 2026

(54) INTERACTION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Yong TANG, Beijing (CN); Zichao Wei, Beijing (CN); Yuying Wei, Beijing (CN)

(21) Appl. No.: 19/414,084

(22) Filed: Dec. 9, 2025

(30) Foreign Application Priority Data
Dec. 18, 2024 (CN) 202411875953.2

(51) Int. Cl. G06T 13/40; G06T 13/20; G06T 13/80

(52) U.S. Cl. CPC G06T 13/40; G06T 13/205; G06T 13/80; G06T 2200/24

(57) ABSTRACT

The present disclosure relates to an interaction method and apparatus, an electronic device, and a storage medium. The method includes: presenting a first page, wherein the first page includes a digital avatar presentation window, the digital avatar presentation window includes a target image, the target image includes a target digital avatar, and the target digital avatar has a digital character corresponding thereto; obtaining conversation input information; obtaining a target video based on the conversation input information and the digital character of the target digital avatar, wherein the target video is a speaking video of the target digital avatar, and in the target video, words spoken by the target digital avatar are feedback information corresponding to the conversation input information; and playing the target video in the digital avatar presentation window.

### CROSS-REFERENCE TO RELATED APPLICATION(S)

The present disclosure claims the priority from the CN patent application No. 202411875953.2 entitled “Interaction method and apparatus, electronic device, and storage medium” filed with the China National Intellectual Property Administration (CNIPA) on Dec. 18, 2024, the contents of which are hereby incorporated by reference in their entirety.

### FIELD

The present disclosure relates to the field of artificial intelligence technologies and, in particular, to an interaction method and apparatus, an electronic device, and a storage medium.

### BACKGROUND

With the rapid development of science and technology, artificial intelligence has become one of the most influential technology fields in the world today. From the early simple machine learning algorithms to the widespread use of deep neural networks today, artificial intelligence has achieved remarkable results in many aspects such as image recognition, speech processing, and natural language understanding.

### SUMMARY

The present disclosure provides an interaction method and apparatus, an electronic device, and a storage medium.

In a first aspect, the present disclosure provides an interaction method, including:
presenting a first page, where the first page includes a digital avatar presentation window; the digital avatar presentation window includes a target image; the target image includes a target digital avatar; and the target digital avatar has a digital character corresponding thereto;
obtaining conversation input information;
obtaining a target video based on the conversation input information and the digital character of the target digital avatar, where the target video is a speaking video of the target digital avatar, and in the target video, words spoken by the target digital avatar are feedback information corresponding to the conversation input information; and
playing the target video in the digital avatar presentation window.

In a second aspect, the present disclosure further provides an interaction apparatus, including:
a first presentation module, configured to present a first page, where the first page includes a digital avatar presentation window; the digital avatar presentation window includes a target image; the target image includes a target digital avatar; and the target digital avatar has a digital character corresponding thereto;
an obtaining module, configured to obtain conversation input information;
a video production module, configured to obtain a target video based on the conversation input information and the digital character of the target digital avatar, where the target video is a speaking video of the target digital avatar, and in the target video, words spoken by the target digital avatar are feedback information corresponding to the conversation input information; and
a second presentation module, configured to play the target video in the digital avatar presentation window.

In a third aspect, the present disclosure further provides an electronic device, including:
one or more processors;
a storage apparatus, configured to store one or more programs,
where the one or more programs, when executed by the one or more processors, cause the one or more processors to implement the interaction method according to the above.

In a fourth aspect, the present disclosure further provides a computer-readable storage medium having stored thereon a computer program that, when executed by a processor, causes the interaction method according to the above to be implemented.

### BRIEF DESCRIPTION OF THE DRAWINGS

The drawings herein, which are incorporated in this specification and constitute a part thereof, illustrate embodiments consistent with the present disclosure and, together with the description, serve to explain the principles of the present disclosure.

In order to more clearly illustrate the technical solutions in the embodiments of the present disclosure or in the prior art, the drawings to be used in the description of the embodiments or the prior art will be briefly introduced below. Obviously, those of ordinary skills in the art may still derive other drawings from these drawings without creative efforts.

FIG. 1 is a flowchart of an interaction method provided by an embodiment of the present disclosure;

FIGS. 2-8 are schematic diagrams of several terminal interfaces provided by an embodiment of the present disclosure;

FIG. 9 is a schematic structural diagram of an interaction apparatus provided by an embodiment of the present disclosure; and

FIG. 10 is a schematic structural diagram of an electronic device provided by an embodiment of the present disclosure.

### DETAILED DESCRIPTION OF EMBODIMENTS

In order to understand the above objectives, features and advantages of the present disclosure more clearly, the solutions of the present disclosure will be further described below. It should be noted that the embodiments of the present disclosure and the features in the embodiments may be combined with each other without conflict.

Many specific details are set forth in the following description to facilitate a full understanding of the present disclosure, but the present disclosure may also be implemented in other ways different from those described herein. Obviously, the embodiments in the specification are part of the embodiments of the present disclosure, but not all of the embodiments.

With the rapid development of science and technology, artificial intelligence has become one of the most influential technology fields in the world today. From the early simple machine learning algorithms to the widespread use of deep neural networks today, artificial intelligence has achieved remarkable results in many aspects such as image recognition, speech processing, and natural language understanding.

However, in the field of digital human interaction, although digital human technologies have emerged, at present, when a digital human interacts with a user, the digital human is mostly presented in a static manner and lacks reactions like a real human, making the interaction between the user and the digital human unnatural.

In order to solve the above technical problems or at least partially solve the above technical problems, the present disclosure provides an interaction method and apparatus, an electronic device, and a storage medium.

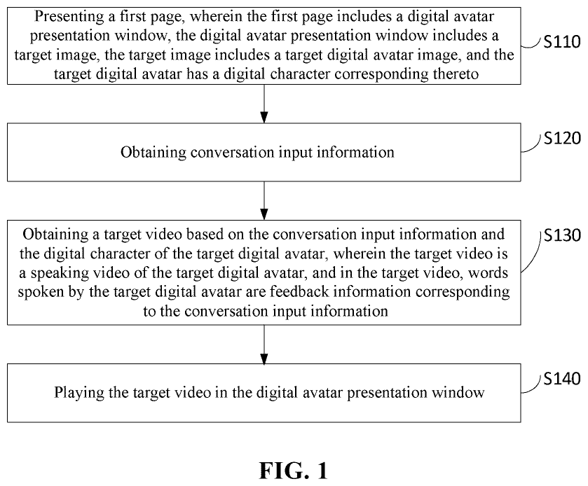

FIG. 1 is a flowchart of an interaction method provided by an embodiment of the present disclosure. The embodiment may be applied to a case of interacting with a digital avatar in a client. The method may be performed by an interaction apparatus, which may be implemented by software and/or hardware and may be configured in an electronic device, such as a terminal, specifically including but not limited to a smart phone, a palmtop computer, a tablet computer, a wearable device with a display screen, a desktop computer, a laptop computer, an all-in-one machine, a smart home device, etc. Alternatively, the embodiment may be applied to a case of interacting with a digital avatar in a server. The method may be performed by an interaction apparatus, which may be implemented by software and/or hardware and may be configured in an electronic device, such as a server.

As shown in FIG. 1, the method may specifically include the following steps.

S110: presenting a first page, where the first page includes a digital avatar presentation window, the digital avatar presentation window includes a target image, the target image includes a target digital avatar image, and the target digital avatar has a digital character corresponding thereto.

A digital avatar is a digital entity representation constructed by a variety of means such as computer graphics technology, artificial intelligence algorithms, and multimedia data processing. It has specific appearance image features, can simulate the appearance image of humans, animals or objects, has behavioral features such as facial expressions and/or body movements, and can also understand natural language and make corresponding responses. In some scenarios, a digital avatar may also make autonomous decisions to complete specific tasks. It may use various interaction interfaces to perform multi-dimensional information exchange with users, including visual, auditory, and even tactile information exchange, and may be widely used in many fields such as film and television entertainment, digital marketing, virtual social networking, education and teaching, and smart customer service.

A digital character may be, for example, a qualification condition for the digital avatar. Specifically, the digital character may be, for example, a qualification for one or more dimensions of the personality of the digital avatar, the environment in which the digital avatar is located, and the behavior pattern of the digital avatar. Different digital avatars have different digital characters. When the same natural language is input to different digital avatars, the responses of the different digital avatars to the same natural language may be different. The response of any digital avatar to the input natural language is in line with its character features. In practice, the digital character may be a person or animal with real-world basis (such as a person in history, or a person in film, television, or literary works), or may be a purely fictional person or animal without real-world basis.

Exemplarily, it is assumed that there are two digital avatars. The digital character of one digital avatar is a wise elder, who is calm and wise, and the environment in which the digital avatar is located is a quiet study. The digital character of the other digital avatar includes an elf character, who is in a fantasy forest environment. It is assumed that when a question about the philosophy of life is input to these two digital avatars, the answer given by the first digital avatar is profound and connotative, while the answer given by the second digital avatar is smart, witty, and full of imagination.

The target image includes the target digital avatar, which may be, for example, to present, in an image manner, the digital avatar that the user desires to have a conversation with. In some scenarios, the target digital avatar may be randomly selected from a plurality of digital avatars, or selected from a plurality of digital avatars that meet a preset condition (such as the most popular, or historically used by the user, or historically most frequently used by the user), or selected by the user from a plurality of digital avatars.

The first page may be, for example, a page that provides the user with a conversation service with the target digital avatar. The digital avatar presentation window may be, for example, a window on the first page that is used to present the target digital avatar. In practice, the target digital avatar may be presented by a static image, a dynamic image, or a video. The target image may be, for example, an image that includes the target digital avatar, which may be a static image or a dynamic image.

S120: obtaining conversation input information.

The conversation input information may be, for example, information input by the user for having a conversation with the target digital avatar. In practice, the conversation input information may be, for example, a question asked to the target digital avatar, or may be a comment on information previously spoken by the target digital avatar.

In practice, the conversation input information may be input in a text form or in an audio form.

S130: obtaining a target video based on the conversation input information and the digital character of the target digital avatar, where the target video is a speaking video of the target digital avatar, and in the target video, words spoken by the target digital avatar are feedback information corresponding to the conversation input information.

The feedback information may be, for example, a verbal response made by the target digital avatar to the conversation input information. Exemplarily, if the conversation input information is a question, the feedback information is an answer to the question expressed in language. If the conversation input information is a statement of an event, the feedback information is a comment on the event expressed in language.

The content of the target video is a video in which the target digital avatar speaks the feedback information. In the target video, while the target digital avatar is speaking the feedback information, there are movements of the muscles of the face (including the mouth) of the target digital avatar, and even body movements. Moreover, the movements (including the facial movements and even the body movements) of the target digital avatar are synchronized with the feedback information to give the user an impression that the heard feedback information is indeed spoken by the target digital avatar.

There are multiple implementation methods for this step, which is not limited in the present application. Exemplarily, the target digital avatar has a language processing model corresponding thereto, and the language processing model has a function of outputting, based on the conversation input information, feedback information that conforms to the digital character of the digital avatar. The implementation method of this step may include: inputting the conversation input information into the language processing model corresponding to the target digital avatar to obtain the feedback information; processing the feedback information into audio information; and obtaining the target video based on the feedback information, the audio information and the target image, where in the target video, the speech of the digital avatar is synchronized with the movements of the digital avatar.

In practice, a one-to-one correspondence between a digital avatar and a language processing model may be set. The language processing model is configured or trained by the digital character of the digital avatar corresponding thereto, and the feedback information output therefrom conforms to the digital character of the digital avatar corresponding thereto.

In practice, if the conversation input information is text information, the conversation input information may be directly input into the language processing model corresponding to the target digital avatar to obtain the feedback information. If the conversation input information is audio information, the conversation input information may be first converted into audio information, and then the audio information is input into the language processing model corresponding to the target digital avatar to obtain the feedback information. The feedback information directly output by the language processing model may be text information.

In the target video, the speech of the digital avatar being synchronized with the movements of the digital avatar may include, for example, that in the target video, the speech of the digital avatar is synchronized with the mouth shape of the digital avatar. Further, it may be set that in the target video, the speech of the digital avatar is synchronized with the body movements of the digital avatar.

Further, there are multiple methods for “obtaining the target video based on the feedback information and the target image”, which is not limited in the present application. Exemplarily, in an embodiment, “obtaining the target video based on the feedback information, the audio information and the target image” includes: adjusting a facial image and/or a body image of the target digital avatar in the target image based on the feedback information to obtain an adjusted target image; and synthesizing the audio information and the adjusted target image to obtain the target video.

Since the target video includes multiple image frames arranged in a certain order, and each of the image frames is obtained by adjusting the facial image and/or the body image of the target digital avatar in the target image based on the feedback information, this means that any two image frames in the target video have the same or similar background.

In another embodiment, “obtaining the target video based on the feedback information, the audio information and the target image” may include: generating a candidate video based on the target image, where the candidate video includes the target digital avatar, the candidate video includes multiple image frames, and at least some of the image frames have different backgrounds; adjusting a facial image and/or a body image of the target digital avatar in the image frames of the candidate video based on the feedback information to obtain an adjusted candidate video; and synthesizing the audio information and the adjusted candidate video to obtain the target video.

The candidate video may be, for example, a video generated by a video generation model with the target image as a guide image. In some scenarios, it may be set that each image frame of the candidate video includes the target digital avatar; or some image frames include the target digital avatar and some image frames do not include the target digital avatar. In the image frames of the candidate video, the rest part other than the target digital avatar is the background. At least some of the image frames in the candidate video have different backgrounds. The candidate video is generated based on the target image, where at least some of the image frames of the candidate video have different backgrounds. The audio information is synthesized with the candidate video in which the facial image and/or the body image of the target digital avatar are adjusted to obtain the target video. The target video may simulate the target digital avatar to make a larger movement, for example, simulate the target digital avatar to enter another room from one room, or simulate objects to quickly flash by behind the target digital avatar when the target digital avatar is moving.

Further, there are multiple specific implementation methods for “processing the feedback information into the audio information”, which is not limited in the present application. Exemplarily, processing the feedback information into the audio information includes: processing the feedback information into the audio information based on the digital character of the target digital avatar, such that the timbre of the audio information corresponds to the digital character of the target digital avatar. Exemplarily, if the digital character of the target digital avatar is a wise elder, the timbre of the audio information obtained from the feedback information is an old timbre, which is in line with the character features of the wise elder. The purpose of such setting is to match the audio information of the subsequently obtained target video with the digital character of the target digital avatar.

S140: playing the target video in the digital avatar presentation window.

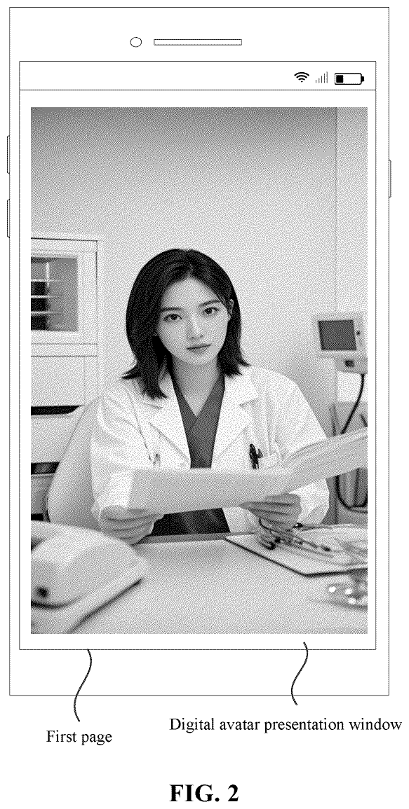

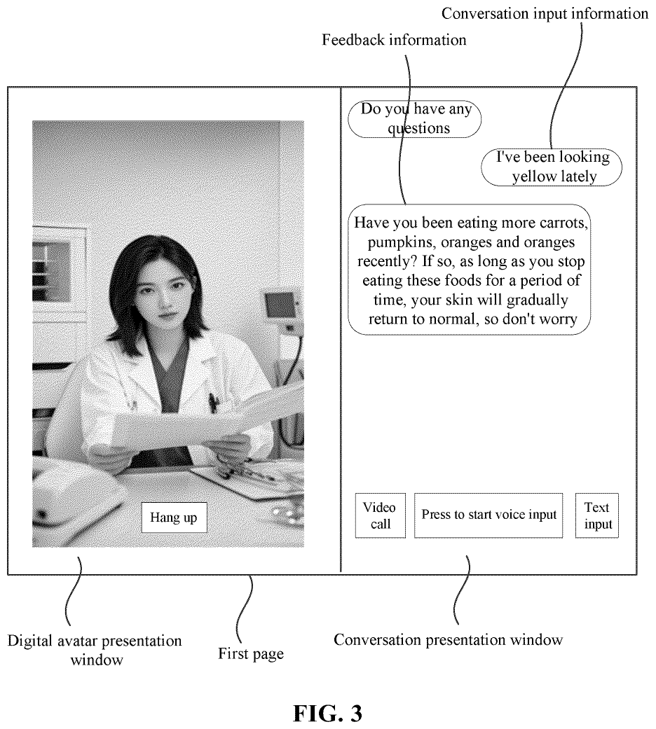

Exemplarily, FIG. 2 and FIG. 3 are schematic diagrams of two first pages given by an embodiment of the present disclosure. The first page in FIG. 2 may be applied to an APP, and the first page in FIG. 3 may be applied to a web end. Referring to FIG. 2 or FIG. 3, the digital avatar presentation window is presented on the first page, the target image including the target digital avatar is presented in the digital avatar presentation window, and the target digital avatar is a lady. It is assumed that the digital character of the lady is a doctor who is calm and has rich medical expertise. If the user inputs conversation input information, such as “I've been looking yellow lately”, in the form of language or text, in the target video played in the digital avatar presentation window, the target digital avatar replies: “Have you been eating more carrots, pumpkins, oranges and oranges recently? If so, as long as you stop eating these foods for a period of time, your skin will gradually return to normal, so don't worry”.

According to the above technical solution, the first page is presented, where the first page includes the digital avatar presentation window, the digital avatar presentation window includes the target image, the target image includes the target digital avatar, and the target digital avatar has the digital character corresponding thereto; the conversation input information is obtained; the target video is obtained based on the conversation input information and the digital character of the target digital avatar, where the target video is the speaking video of the target digital avatar, and in the target video, the words spoken by the target digital avatar are the feedback information corresponding to the conversation input information; and the target video is played in the digital avatar presentation window. The technical solution essentially provides a method for the digital avatar to interact with the user in the dynamic manner. In the interaction process, the digital avatar is dynamic, for example, has the facial and/or body movements when speaking, and the words spoken by the digital avatar conform to its character, thereby improving the realism of the interaction between the digital avatar and the user.

Based on the above technical solution, optionally, the first page further includes a conversation presentation window, and the method further includes: presenting in the conversation presentation window the conversation input information and the feedback information.

The conversation presentation window may be, for example, an area on the first page that is used to present the conversation input information and the feedback information.

Exemplarily, referring to FIG. 3, the first page includes the conversation presentation window, in which the conversation input information and the feedback information are presented in the form of message bubbles.

By setting to present in the conversation presentation window the conversation input information and the feedback information, the user may be helped to understand and review the content of the conversation with the target digital avatar.

Further, the first page further includes a conversation input option. The presentation position of the conversation input option may be in the digital avatar presentation window or in the conversation presentation window. Exemplarily, in FIG. 3, a “press to start voice input” option and a “text input” option belong to the conversation input option. If the user triggers (such as clicks, long presses, or hovers over) the “press to start voice input” option, the voice of the user is recorded, and the recorded voice of the user is used as the conversation input information. If the user triggers (such as clicks, long presses, or hovers over) the “text input” option, a text input box is presented, in which the user may input text information. The text information input by the user in the text input box is used as the conversation input information.

Based on the above technical solutions, optionally, the method may further include: obtaining a user image in a video call mode with the target digital avatar; and presenting the user image in a local call end presentation window of the first page.

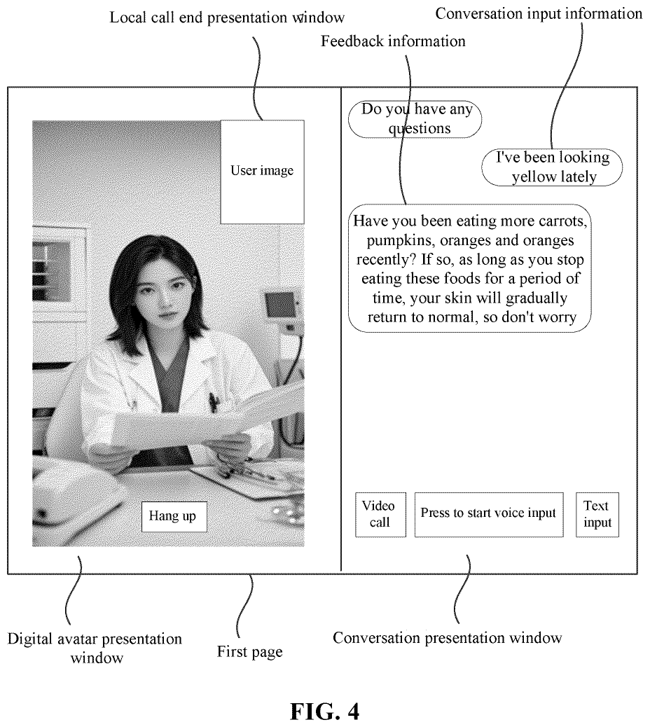

Exemplarily, referring to FIG. 3, the first page includes a “video call” option. If the user triggers (such as clicks, long presses, or hovers over) the “video call” option, the video call mode with the target digital avatar is entered. Referring to FIG. 4, in this mode, the electronic device invokes a camera to perform image acquisition on the user to obtain the user image, and the user image is presented in the local call end presentation window of the first page. In this way, a scenario in which the user has a video call with the target digital avatar may be simulated, bringing a realistic immersive experience to the user.

Based on the above technical solution, optionally, S110 may include: presenting a digital avatar presentation page, where the digital avatar presentation page includes multiple digital avatar identifications, and different digital avatars have different digital characters; and presenting the first page in response to a selection operation for a target digital avatar identification in the digital avatar presentation page.

The digital avatar presentation page may be, for example, a page that is used to present digital avatar identifications. Optionally, the digital avatar presentation page includes multiple digital avatar identifications. The digital avatar identification may be, for example, a page that distinguishes one digital avatar from other digital avatars. Exemplarily, the digital avatar identification includes at least one of the following: a digital avatar image, a digital avatar name, and digital character description information of the digital avatar.

When the digital avatar presentation page includes multiple digital avatar identifications, the digital avatar referred to by the digital avatar identification selected by the user is the target digital avatar. The selection operation for the target digital avatar identification may be, for example, a click operation or a drag operation for the target digital avatar identification.

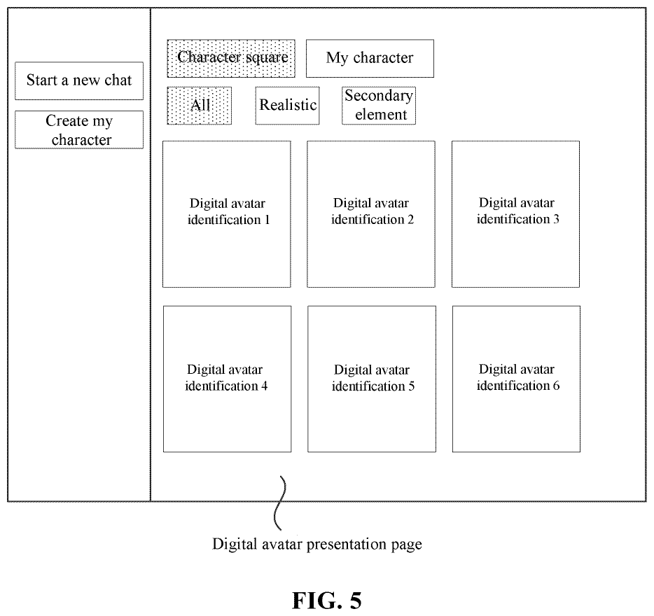

Exemplarily, referring to FIG. 5, the digital avatar presentation page includes multiple digital avatar identifications. If the user clicks on a digital avatar identification 2, referring to FIG. 3, the first page is presented. On the first page, the target image including a digital avatar 2 is presented in the digital avatar presentation window.

The digital avatar presentation page is presented, where the digital avatar presentation page includes multiple digital avatar identifications, and different digital avatars have different digital characters; and the first page is presented in response to the selection operation for the target digital avatar identification in the digital avatar presentation page. The technical solution essentially provides the user with multiple digital avatars by means of the digital avatar presentation page, such that the user may select and use a digital avatar that meets his/her own needs according to his/her own needs, thereby meeting the user's use needs in specific scenarios such as socializing, expression, and working.

In a practical application scenario, a plurality of digital avatars may be classified according to various standards. Each category has a label matching therewith, and the digital avatar presentation page includes multiple labels. When a certain label is in a selected state, the digital avatar presentation page presents digital avatars corresponding to the label. Exemplarily, referring to FIG. 5, “character square”, “my character”, “all”, “realistic”, and “secondary element” on the page are all labels. If “character square” and “all” are both in the selected state, identification information about all digital avatars created by different users is presented on the digital avatar presentation page. If “character square” and “realistic” are both in the selected state, identification information about realistic digital avatars created by different users is presented on the digital avatar presentation page. If “my character” and “all” are both in the selected state, identification information about all digital avatars created by the same user is presented on the digital avatar presentation page. If “my character” and “realistic” are both in the selected state, identification information about realistic digital avatars created by the same user is presented on the digital avatar presentation page.

Based on the above technical solution, optionally, the method may further include: presenting a second page, where the second page includes a digital avatar creation option; presenting a digital avatar creation page in response to a selection operation for the digital avatar creation option; collecting digital avatar material and digital character description information of a digital avatar through the digital avatar creation page, where the digital avatar material includes a video or an image of the digital avatar; and determining a target image including the digital avatar based on the digital avatar material and the character description information, and configuring a language processing model corresponding to the digital avatar for the digital avatar.

The second page may be, for example, a page that includes the digital avatar creation option. In some scenarios, the second page may be the digital avatar presentation page.

The digital avatar creation option may be, for example, an option that may guide the user to the digital avatar creation page. The selection operation for the digital avatar creation option may be, for example, a click operation, a drag operation, or a slide operation for the digital avatar creation option.

The digital avatar material may be, for example, a basic material used to construct the digital avatar, which is used to define the specific form of the digital avatar. It may be presented in the form of a video or an image. For example, if the user desires to create a digital avatar in the shape of a kitten, he/she may input an image or a video featuring a kitten.

The digital character description information may include, for example, the personality of the digital avatar and/or the environment in which the digital avatar is located.

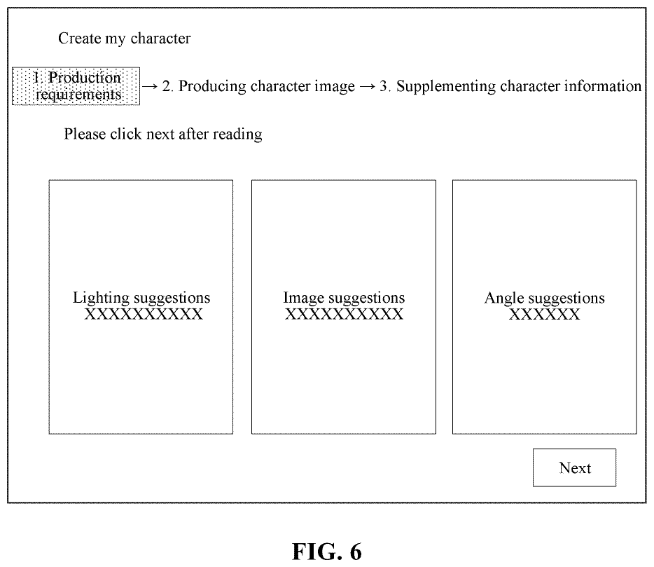

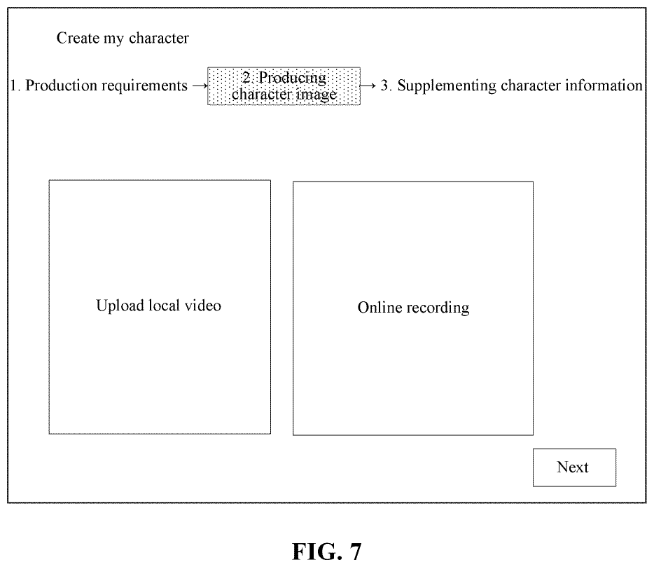

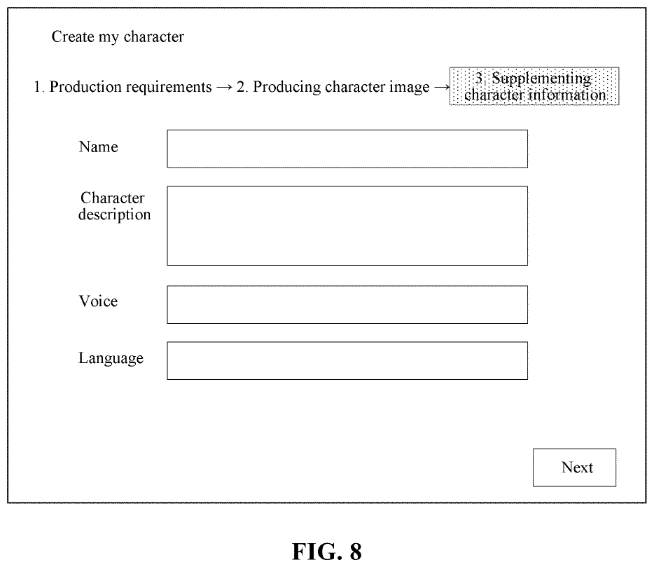

Exemplarily, referring to FIG. 5, since the page includes a “create my character” option, and the “create my character” option belongs to the digital avatar creation option, the page may also be regarded as the second page. If the user clicks on the “create my character” option, referring to FIG. 6, the digital avatar creation page is presented. In this design, the digital avatar creation is divided into three steps. Step 1: production requirements; step 2: character image production; and step 3: character information supplement. The digital avatar creation page in FIG. 6 corresponds to step 1, which is used to assist the user to understand the production requirements. The digital avatar creation page in FIG. 7 corresponds to step 2, which is used to collect the digital avatar material. The digital avatar creation page in FIG. 8 corresponds to step 3, which is used to collect the digital character description information.

The digital avatar material (including the video or the image of the digital avatar) and the digital character description information of the digital avatar are collected through the digital avatar creation page. The target image including the digital avatar is determined based on the material and the character description information, and the language processing model corresponding to the digital avatar is configured for the digital avatar. The technical solution essentially allows the user to set the digital avatar according to his/her own needs, thereby meeting the personalized use needs of the user.

It may be understood that before using the technical solutions disclosed in the embodiments of the present disclosure, the user shall be informed of the type, the scope of use, the use scenarios, etc., of personal information involved in the present disclosure in an appropriate manner and the authorization of the user shall be obtained according to relevant laws and regulations.

For example, in response to receiving an active request from the user, prompt information is sent to the user to clearly inform the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining the authorization of the user is only illustrative and does not limit the implementations of the present disclosure, and other manners that satisfy the relevant laws and regulations may also be applied to the implementations of the present disclosure.

It should be noted that, for the sake of simple description, the foregoing method embodiments are all expressed as a series of action combinations, but those skilled in the art should know that the present invention is not limited by the described action order, because according to the present invention, some steps may be performed in other orders or simultaneously. Secondly, those skilled in the art should also know that the embodiments described in the specification all belong to preferred embodiments, and the involved actions and modules are not necessarily required by the present invention.

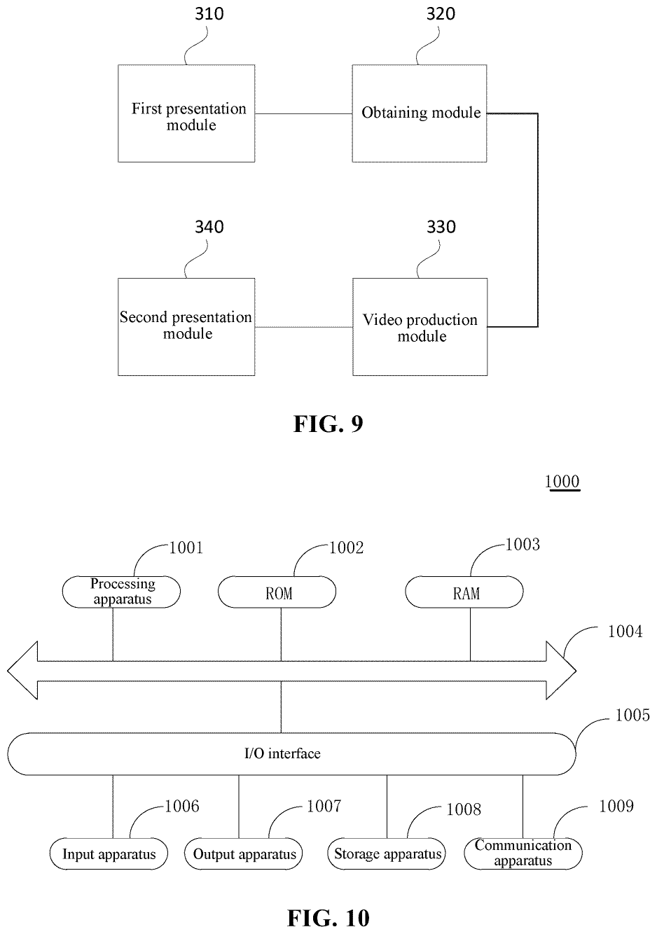

FIG. 9 is a schematic structural diagram of an interaction apparatus according to an embodiment of the present disclosure. The interaction apparatus provided by the embodiment of the present disclosure may be configured in a client or in a server. Referring to FIG. 9, the interaction apparatus specifically includes a first presentation module 310, an obtaining module 320, a video production module 330, and a second presentation module 340.

The first presentation module 310 is configured to present a first page, where the first page includes a digital avatar presentation window, the digital avatar presentation window includes a target image, the target image includes a target digital avatar, and the target digital avatar has a digital character corresponding thereto.

The obtaining module 320 is configured to obtain conversation input information.

The video production module 330 is configured to obtain a target video based on the conversation input information and the digital character of the target digital avatar, where the target video is a speaking video of the target digital avatar, and in the target video, words spoken by the target digital avatar are feedback information corresponding to the conversation input information.

The second presentation module 340 is configured to play the target video in the digital avatar presentation window.

Further, the target digital avatar has a language processing model corresponding thereto, and the language processing model has a function of outputting, based on the conversation input information, the feedback information that conforms to the digital character of the digital avatar. The video production module 330 is configured to:
input the conversation input information into the language processing model corresponding to the target digital avatar to obtain the feedback information;
process the feedback information into audio information; and
obtain the target video based on the feedback information, the audio information, and the target image, where in the target video, speech of the digital avatar is synchronized with actions of the digital avatar.

Further, the video production module 330 is configured to:
adjust a facial image and/or a body image of the target digital avatar in the target image based on the feedback information to obtain an adjusted target image; and
synthesize the audio information and the adjusted target image to obtain the target video.

Further, the video production module 330 is configured to:
generate a candidate video based on the target image, where the candidate video includes the target digital avatar, the candidate video includes multiple image frames, and at least some of the image frames have different backgrounds;
adjust a facial image and/or a body image of the target digital avatar in the image frames of the candidate video based on the feedback information to obtain an adjusted candidate video; and
synthesize the audio information and the adjusted candidate video to obtain the target video.

Further, the video production module 330 is configured to:
process the feedback information into the audio information based on the digital character of the target digital avatar, such that a timbre of the audio information corresponds to the digital character of the target digital avatar.

Further, the apparatus further includes a third presentation module, which is configured to:
present in the conversation presentation window the conversation input information and the feedback information.

Further, the apparatus further includes a fourth presentation module, which is configured to:
obtain a user image in a video call mode with the target digital avatar; and
present the user image in a local call end presentation window of the first page.

Further, the first presentation module 310 is configured to:
present a digital avatar presentation page, where the digital avatar presentation page includes multiple digital avatar identifications, and different digital avatars have different digital characters; and
present the first page in response to a selection operation for a target digital avatar identification in the digital avatar presentation page.

Further, the apparatus further includes a creation module, which is configured to:
present a second page, where the second page includes a digital avatar creation option;
present a digital avatar creation page in response to a selection operation for the digital avatar creation option;
collect digital avatar material and digital character description information of a digital avatar through the digital avatar creation page, where the digital avatar material includes a video or an image of the digital avatar; and
determine a target image including the digital avatar based on the digital avatar material and the character description information, and configure a language processing model corresponding to the digital avatar for the digital avatar.

The interaction apparatus provided by the embodiment of the present disclosure may perform the steps performed by the client or the server in the interaction method provided by the method embodiment of the present disclosure, and has the steps performed and the beneficial effects, which are not repeated here.

FIG. 10 is a schematic structural diagram of an electronic device according to an embodiment of the present disclosure. Reference is made specifically to FIG. 10 below, which is a schematic structural diagram of an electronic device 1000 suitable for implementing the embodiments of the present disclosure. The electronic device 1000 in the embodiment of the present disclosure may include, but is not limited to, mobile terminals such as a mobile phone, a laptop computer, a digital broadcast receiver, a personal digital assistant (PDA), a tablet computer (PAD), a portable multimedia player (PMP), a vehicle-mounted terminal (such as a vehicle navigation terminal), and a wearable electronic device, and fixed terminals such as a digital TV, a desktop computer, and a smart home device. The electronic device shown in FIG. 10 is only an example, and should not impose any limitation on the function and the scope of use of the embodiments of the present disclosure.

As shown in FIG. 10, the electronic device 1000 may include a processing apparatus 1001 (such as a central processing unit and a graphics processor). The processing apparatus 1001 may perform various appropriate actions and processing based on a program stored in a read-only memory (ROM) 1002 or a program loaded from a storage apparatus 1008 into a random access memory (RAM) 1003 to implement the interaction method of the embodiments according to the present disclosure. The RAM 1003 further stores various programs and information required for the operation of the electronic device 1000. The processing apparatus 1001, the ROM 1002, and the RAM 1003 are interconnected by means of a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a loudspeaker, and a vibrator; the storage apparatus 1008 including, for example, a magnetic tape and a hard disk; and a communication apparatus 1009. The communication apparatus 1009 may allow the electronic device 1000 to perform wireless or wired communication with other devices to exchange information. Although FIG. 10 shows the electronic device 1000 having various apparatuses, it should be understood that it is not required to implement or provide all of the shown apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried by a non-transitory computer-readable medium. The computer program includes program code for performing the method shown in the flowchart, thereby implementing the interaction method as described above. In such an embodiment, the computer program may be downloaded and installed from a network via the communication apparatus 1009, or installed from the storage apparatus 1008, or installed from the ROM 1002. When the computer program is executed by the processing apparatus 1001, the above-mentioned functions defined in the method of the embodiments of the present disclosure are executed.

It should be noted that the above-mentioned computer-readable medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semi-conductive system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus, or device. In the present disclosure, the computer-readable signal medium may include an information signal propagated on a baseband or as a part of a carrier, and computer-readable program code is carried by the information signal. The information signal propagated in this way may be in many forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to: a wire, an optical cable, a radio frequency (RF), etc., or any suitable combination of the above.

In some implementations, a client and a server may communicate using any known or future developed network protocol, such as the HyperText Transfer Protocol (HTTP), and may be interconnected with any form or medium of digital information communication (for example, a communication network). Examples of the communication network include a local area network (“LAN”), a wide area network (“WAN”), an internet (for example, the Internet), a peer-to-peer network (for example, an Ad-Hoc network), and any network known or to be developed in the future.

The above-mentioned computer-readable medium may be included in the above-mentioned electronic device, or may exist alone without being assembled into the electronic device.

The above-mentioned computer-readable medium carries one or more programs, and when the one or more programs are executed by the electronic device, the electronic device:
presents a first page, where the first page includes a digital avatar presentation window, the digital avatar presentation window includes a target image, the target image includes a target digital avatar, and the target digital avatar has a digital character corresponding thereto;
obtains conversation input information;
obtains a target video based on the conversation input information and the digital character of the target digital avatar, where the target video is a speaking video of the target digital avatar, and in the target video, words spoken by the target digital avatar are feedback information corresponding to the conversation input information; and
plays the target video in the digital avatar presentation window.

Optionally, when the one or more programs are executed by the electronic device, the electronic device may also perform the other steps described in the above embodiments.

The computer program code for performing the operations of the present disclosure may be written in one or more programming languages or a combination thereof, where the programming languages include but are not limited to object-oriented programming languages such as Java, Smalltalk, and C++, and further include conventional procedural programming languages such as “C” language or similar programming languages. The program code may be executed entirely on a user computer, partly on a user computer, as a stand-alone software package, partly on a user computer and partly on a remote computer, or entirely on a remote computer or a server. In the case involving a remote computer, the remote computer may be connected to the user computer through any kind of network, including a local area network (LAN) or a wide area network (WAN), or may be connected to an external computer (for example, connected via the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or by hardware. The name of a unit does not constitute a limitation on the unit itself under certain circumstances.

The functions described above herein may be performed at least partly by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, the present disclosure provides an electronic device, including:
one or more processors;
a memory, configured to store one or more programs,
where the one or more programs, when executed by the one or more processors, cause the one or more processors to implement the interaction method according to any one of the embodiments provided in the present disclosure.

According to one or more embodiments of the present disclosure, the present disclosure provides a computer-readable storage medium having stored thereon a computer program that, when executed by a processor, causes the interaction method according to any one of the embodiments provided in the present disclosure to be implemented.

An embodiment of the present disclosure further provides a computer program product, which includes a computer program or instructions. When the computer program or instructions are executed by a processor, the interaction method as described above is implemented.

It should be noted that in this paper, relational terms such as “first” and “second” are only used to distinguish one entity or operation from another entity or operation, and do not necessarily require or imply any actual relationship or order between these entities or operations. Moreover, terms “include”, “include” or any other variation thereof are intended to cover non-exclusive inclusion, such that a process, method, object or device including a series of elements includes not only those elements, but also other elements not explicitly listed or elements inherent to such process, method, object or device. Without further restrictions, an element defined by a phrase “including a” does not exclude that there are other identical elements in the process, method, object or device that includes the element.

The above descriptions are only specific implementations of the present disclosure, such that those skilled in the art may understand or implement the present disclosure. Various modifications to these embodiments will be obvious to those skilled in the art, and the general principles defined herein may be implemented in other embodiments without departing from the spirit or scope of the present disclosure. Therefore, the present disclosure will not be limited to these embodiments described herein, but rather to the widest scope consistent with the principles and novel features disclosed herein.

I/We claim:

1. An interaction method, comprising:
presenting a first page, wherein the first page comprises a digital avatar presentation window, the digital avatar presentation window comprises a target image, the target image comprises a target digital avatar, and the target digital avatar has a digital character corresponding thereto;
obtaining conversation input information;
obtaining a target video based on the conversation input information and the digital character of the target digital avatar, wherein the target video is a speaking video of the target digital avatar, and in the target video, words spoken by the target digital avatar are feedback information corresponding to the conversation input information; and
playing the target video in the digital avatar presentation window.

2. The method of claim 1, wherein the target digital avatar has a language processing model corresponding thereto, the language processing model has a function of outputting, based on the conversation input information, feedback information that conforms to the digital character of the digital avatar, and obtaining the target video based on the conversation input information and the digital character of the target digital avatar comprises:
inputting the conversation input information into the language processing model corresponding to the target digital avatar to obtain the feedback information;
processing the feedback information into audio information; and
obtaining the target video based on the feedback information, the audio information, and the target image, wherein in the target video, speech of the digital avatar is synchronized with actions of the digital avatar.

3. The method of claim 2, wherein obtaining the target video based on the feedback information, the audio information, and the target image comprises:
adjusting a facial image and/or a body image of the target digital avatar in the target image based on the feedback information to obtain an adjusted target image; and
synthesizing the audio information and the adjusted target image to obtain the target video.

4. The method of claim 2, wherein obtaining the target video based on the feedback information, the audio information, and the target image comprises:
generating a candidate video based on the target image, wherein the candidate video comprises the target digital avatar, the candidate video comprises multiple image frames, and at least some of the image frames have different backgrounds;
adjusting a facial image and/or a body image of the target digital avatar in the image frames of the candidate video based on the feedback information to obtain an adjusted candidate video; and
synthesizing the audio information and the adjusted candidate video to obtain the target video.

5. The method of claim 2, wherein processing the feedback information into the audio information comprises:
processing the feedback information into the audio information based on the digital character of the target digital avatar, such that a timbre of the audio information corresponds to the digital character of the target digital avatar.

6. The method of claim 1, wherein the first page further comprises a conversation presentation window, and the method further comprises:
presenting in the conversation presentation window the conversation input information and the feedback information.

7. The method of claim 1, further comprising:
obtaining a user image in a video call mode with the target digital avatar; and
presenting the user image in a local call end presentation window of the first page.

8. The method of claim 1, wherein presenting the first page further comprises:
presenting a digital avatar presentation page, wherein the digital avatar presentation page comprises multiple digital avatar identifications, and different digital avatars have different digital characters; and
presenting the first page in response to a selection operation for a target digital avatar identification in the digital avatar presentation page.

9. The method of claim 1, further comprising:
presenting a second page, wherein the second page comprises a digital avatar creation option;
presenting a digital avatar creation page in response to a selection operation for the digital avatar creation option;
collecting digital avatar material and digital character description information of a digital avatar through the digital avatar creation page, wherein the digital avatar material comprises a video or an image of the digital avatar; and
determining a target image comprising the digital avatar based on the digital avatar material and the character description information, and configuring a language processing model corresponding to the digital avatar for the digital avatar.

10. An electronic device, comprising:
one or more processors;
a storage apparatus, configured to store one or more programs,
wherein the one or more programs, when executed by the one or more processors, cause the one or more processors to implement an interaction method comprising:
presenting a first page, wherein the first page comprises a digital avatar presentation window, the digital avatar presentation window comprises a target image, the target image comprises a target digital avatar, and the target digital avatar has a digital character corresponding thereto;
obtaining conversation input information;
obtaining a target video based on the conversation input information and the digital character of the target digital avatar, wherein the target video is a speaking video of the target digital avatar, and in the target video, words spoken by the target digital avatar are feedback information corresponding to the conversation input information; and
playing the target video in the digital avatar presentation window.

11. The electronic device of claim 10, wherein the target digital avatar has a language processing model corresponding thereto, the language processing model has a function of outputting, based on the conversation input information, feedback information that conforms to the digital character of the digital avatar, and obtaining the target video based on the conversation input information and the digital character of the target digital avatar comprises:
inputting the conversation input information into the language processing model corresponding to the target digital avatar to obtain the feedback information;
processing the feedback information into audio information; and
obtaining the target video based on the feedback information, the audio information, and the target image, wherein in the target video, speech of the digital avatar is synchronized with actions of the digital avatar.

12. The electronic device of claim 11, wherein obtaining the target video based on the feedback information, the audio information, and the target image comprises:
adjusting a facial image and/or a body image of the target digital avatar in the target image based on the feedback information to obtain an adjusted target image; and
synthesizing the audio information and the adjusted target image to obtain the target video.

13. The electronic device of claim 11, wherein obtaining the target video based on the feedback information, the audio information, and the target image comprises:
generating a candidate video based on the target image, wherein the candidate video comprises the target digital avatar, the candidate video comprises multiple image frames, and at least some of the image frames have different backgrounds;
adjusting a facial image and/or a body image of the target digital avatar in the image frames of the candidate video based on the feedback information to obtain an adjusted candidate video; and
synthesizing the audio information and the adjusted candidate video to obtain the target video.

14. The electronic device of claim 11, wherein processing the feedback information into the audio information comprises:
processing the feedback information into the audio information based on the digital character of the target digital avatar, such that a timbre of the audio information corresponds to the digital character of the target digital avatar.

15. The electronic device of claim 10, wherein the first page further comprises a conversation presentation window, and the method further comprises:
presenting in the conversation presentation window the conversation input information and the feedback information.

16. The electronic device of claim 10, wherein the method further comprises:
obtaining a user image in a video call mode with the target digital avatar; and
presenting the user image in a local call end presentation window of the first page.

17. The electronic device of claim 10, wherein presenting the first page further comprises:
presenting a digital avatar presentation page, wherein the digital avatar presentation page comprises multiple digital avatar identifications, and different digital avatars have different digital characters; and
presenting the first page in response to a selection operation for a target digital avatar identification in the digital avatar presentation page.

18. The electronic device of claim 10, further comprising:
presenting a second page, wherein the second page comprises a digital avatar creation option;
presenting a digital avatar creation page in response to a selection operation for the digital avatar creation option;
collecting digital avatar material and digital character description information of a digital avatar through the digital avatar creation page, wherein the digital avatar material comprises a video or an image of the digital avatar; and
determining a target image comprising the digital avatar based on the digital avatar material and the character description information, and configuring a language processing model corresponding to the digital avatar for the digital avatar.

19. A non-transitory computer-readable storage medium having stored thereon a computer program that, when executed by a processor, implement an interaction method comprising:
presenting a first page, wherein the first page comprises a digital avatar presentation window, the digital avatar presentation window comprises a target image, the target image comprises a target digital avatar, and the target digital avatar has a digital character corresponding thereto;
obtaining conversation input information;
obtaining a target video based on the conversation input information and the digital character of the target digital avatar, wherein the target video is a speaking video of the target digital avatar, and in the target video, words spoken by the target digital avatar are feedback information corresponding to the conversation input information; and
playing the target video in the digital avatar presentation window.

20. The non-transitory computer-readable storage medium of claim 19, wherein the target digital avatar has a language processing model corresponding thereto, the language processing model has a function of outputting, based on the conversation input information, feedback information that conforms to the digital character of the digital avatar, and obtaining the target video based on the conversation input information and the digital character of the target digital avatar comprises:
inputting the conversation input information into the language processing model corresponding to the target digital avatar to obtain the feedback information;
processing the feedback information into audio information; and
obtaining the target video based on the feedback information, the audio information, and the target image, wherein in the target video, speech of the digital avatar is synchronized with actions of the digital avatar.
